(19) United States
(12) Patent Application Publication
(10) Pub. No.: US 2023/0194272 A1
(43) Pub. Date: Jun. 22, 2023

(54) SERVER APPARATUS, SYSTEM, AND OPERATING METHOD OF SYSTEM

(71) Applicant: TOYOTA JIDOSHA KABUSHIKI KAISHA, Toyota-shi (JP)

(72) Inventors: Chikage KUBO, Chofu-shi (JP); Kazuya NISHIMURA, Anjo-shi (JP); Wataru MINOURA, Nagoya-shi (JP); Yuki TATSUMOTO, Seto-shi (JP); Soutaro KANEKO, Nagoya-shi (JP)

(21) Appl. No.: 18/063,161

(22) Filed: Dec. 8, 2022

(30) Foreign Application Priority Data
Dec. 22, 2021 (JP) 2021-208724

(51) Int. Cl. G01C 21/34; H04L 67/52; H04L 67/12; G06Q 30/0208; G06Q 50/30

(52) U.S. Cl. CPC G01C 21/3438; H04L 67/52; H04L 67/12; G06Q 30/0208; G06Q 50/30

(57) ABSTRACT

A server apparatus includes a communication interface and a controller configured to transmit and receive information to and from other apparatuses via the communication interface. When the controller receives information for reserving use of a vehicle from a terminal apparatus, and a distance between an end point of a first use and a start point of a second use that starts after the first use is equal to or less than a reference distance, the controller is configured to transmit a movement instruction to a first terminal apparatus corresponding to the first use for a user to move the vehicle to the start point of the second use at an end of the first use.

### CROSS-REFERENCE TO RELATED APPLICATION

This application claims priority to Japanese Patent Application No. 2021-208724, filed on Dec. 22, 2021, the entire contents of which are incorporated herein by reference.

### TECHNICAL FIELD

The present disclosure relates to a server apparatus, a system, and an operating method of a system.

### BACKGROUND

Various technologies have been proposed to support vehicle management in car sharing, in which vehicles are shared by a plurality of users. For example, Patent Literature (PTL) 1 discloses technology for managing the status of staff members participating in a car sharing service.

### CITATION LIST

### Patent Literature

PTL 1: JP 2017-215769 A

### SUMMARY

There is room for improvement in the management of vehicles in car sharing.

A server apparatus and the like that can improve vehicle management are disclosed below.

A server apparatus according to the present disclosure includes:

a communication interface; and

a controller configured to transmit and receive information to and from other apparatuses via the communication interface, wherein

when the controller receives information for reserving use of a vehicle from a terminal apparatus, and a distance between an end point of a first use and a start point of a second use that starts after the first use is equal to or less than a reference distance, the controller is configured to transmit a movement instruction to a first terminal apparatus corresponding to the first use for a user to move the vehicle to the start point of the second use at an end of the first use.

A system according to the present disclosure includes a server apparatus and a plurality of terminal apparatuses, the server apparatus and the terminal apparatuses being configured to transmit and receive information to and from each other, wherein

when the server apparatus receives information for reserving use of a vehicle from a terminal apparatus among the plurality of terminal apparatuses, and a distance between an end point of a first use and a start point of a second use that starts after the first use is equal to or less than a reference distance, the server apparatus is configured to transmit a movement instruction to a first terminal apparatus corresponding to the first use for a user to move the vehicle to the start point of the second use at an end of the first use, and

the first terminal apparatus receives the movement instruction.

An operating method of a system in the present disclosure is an operating method of a system including a server apparatus and a plurality of terminal apparatuses, the server apparatus and the terminal apparatuses being configured to transmit and receive information to and from each other, the operating method including:

transmitting, by the server apparatus, a movement instruction when the server apparatus receives information for reserving use of a vehicle from a terminal apparatus among the plurality of terminal apparatuses, and a distance between an end point of a first use and a start point of a second use that starts after the first use is equal to or less than a reference distance, the server apparatus transmitting the movement instruction to a first terminal apparatus corresponding to the first use for a user to move the vehicle to the start point of the second use at an end of the first use; and

receiving, by the first terminal apparatus, the movement instruction.

According to the server apparatus and the like of the present disclosure, vehicle management can be improved.

### BRIEF DESCRIPTION OF THE DRAWINGS

In the accompanying drawings:

FIG. 1 is a diagram illustrating an example configuration of an information processing system;

FIG. 2 is a diagram illustrating an example configuration of a server apparatus;

FIG. 3 is a diagram illustrating an example configuration of a terminal apparatus;

FIG. 4 is a diagram illustrating a configuration example of a vehicle;

FIG. 5A is a sequence diagram illustrating an operation example of the information processing system;

FIG. 5B is a sequence diagram illustrating an operation example of the information processing system; and

FIG. 6 is a flowchart illustrating an operation example of the server apparatus.

### DETAILED DESCRIPTION

Embodiments are described below.

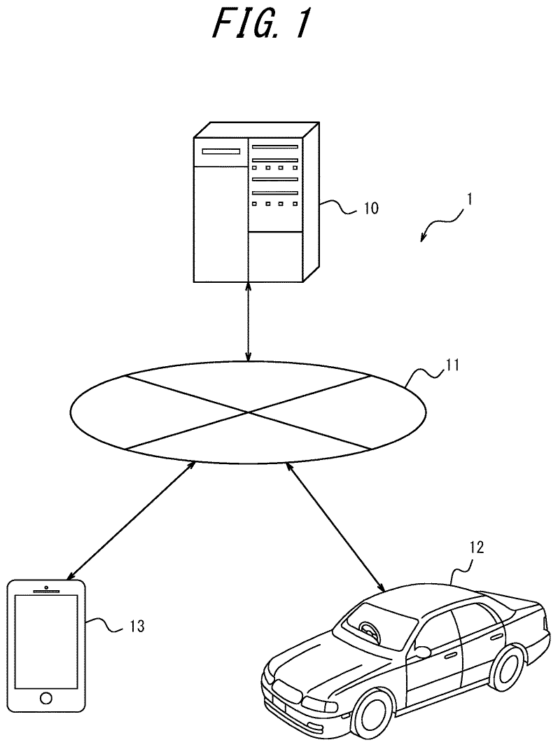

FIG. 1 is a diagram illustrating a configuration example of an information processing system according to an embodiment. An information processing system 1 includes one or more each of a server apparatus 10, a vehicle 12, and a terminal apparatus 13 communicably connected to each other via a network 11. The server apparatus 10 is, for example, a server computer that belongs to a cloud computing system or other computing system and functions as a server that implements various functions. The vehicle 12 is a vehicle used in car sharing and is a passenger car, a commercial vehicle, or the like provided with communication functions and information processing functions. The vehicle 12 is connected to the network 11 via a mobile communication network. The vehicle 12 is driven manually, but a portion of driving may be automated. The vehicle 12 is any type of automobile such as a gasoline vehicle, a Battery Electric Vehicle (BEV), a Hybrid Electric Vehicle (HEV), a Plug-in Hybrid Electric Vehicle (PHEV), or a Fuel Cell Electric Vehicle (FCEV). The terminal apparatus 13 is an information processing apparatus used by the user of the vehicle 12. Examples of the terminal apparatus 13 include a smartphone, a tablet terminal, and a personal computer (PC). The network 11 is the Internet, for example, but may also be an ad-hoc network, a LAN, a Metropolitan Area Network (MAN), other networks, or a combination of two or more thereof.

In the present embodiment, the information processing system 1 supports the management of the vehicle 12 as a shared vehicle in car sharing. When the server apparatus 10 receives information for reserving use of the vehicle 12 from the terminal apparatus 13, and the distance between the end point of a first use and the start point of a second use that starts after the first use is equal to or less than a reference distance, the server apparatus 10 transmits a movement instruction to a first terminal apparatus 13 corresponding to the first use for the user to move the vehicle to the start point of the second use at the end of the first use. With this configuration, the information processing system 1 assists the user of the vehicle 12 to move the vehicle 12 to the point at which the next user will start using the vehicle 12. The start point and end point of use may be stations, established in any appropriate areas, by a car sharing service provider for storage, maintenance, and standby of the vehicle 12, or the start point and end point may be any appropriate points designated by the user. According to the information processing system 1, the next user can start using the vehicle 12 at the desired location, which improves the management of the vehicle 12 by contributing to user convenience.

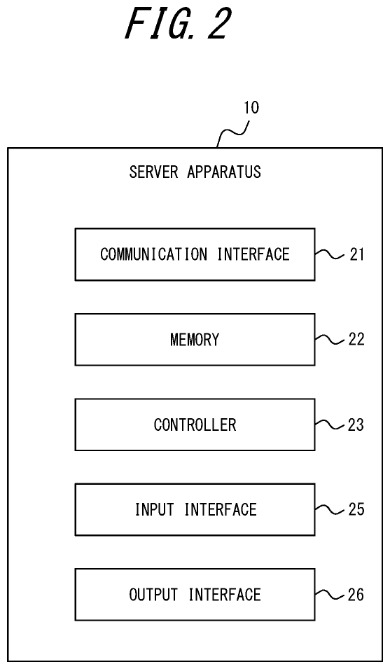

FIG. 2 illustrates an example configuration of the server apparatus 10. The server apparatus 10 includes a communication interface 21, a memory 22, a controller 23, an input interface 25, and an output interface 26. The server apparatus 10 is, for example, a single computer. The server apparatus 10 may be two or more computers that are communicably connected to each other and operate in cooperation. In this case, the configuration illustrated in FIG. 2 can be arranged among two or more computers as appropriate.

The communication interface 21 includes one or more interfaces for communication. The interface for communication is, for example, a LAN interface. The communication interface 21 receives information to be used for the operations of the server apparatus 10 and transmits information obtained by the operations of the server apparatus 10. The server apparatus 10 is connected to the network 11 by the communication interface 21 and communicates information with the vehicle 12 or the terminal apparatus 13 via the network 11.

The memory 22 includes, for example, one or more semiconductor memories, one or more magnetic memories, one or more optical memories, or a combination of at least two of these types, to function as main memory, auxiliary memory, or cache memory. The semiconductor memory is, for example, Random Access Memory (RAM) or Read Only Memory (ROM). The RAM is, for example, Static RAM (SRAM) or Dynamic RAM (DRAM). The ROM is, for example, Electrically Erasable Programmable ROM (EEPROM). The memory 22 stores information to be used for the operations of the server apparatus 10 and information obtained by the operations of the server apparatus 10.

The controller 23 includes one or more processors, one or more dedicated circuits, or a combination thereof. The processor is a general purpose processor, such as a central processing unit (CPU), or a dedicated processor, such as a graphics processing unit (GPU), specialized for a particular process. The dedicated circuit is, for example, a field-programmable gate array (FPGA), an application specific integrated circuit (ASIC), or the like. The controller 23 executes information processing related to operations of the server apparatus 10 while controlling components of the server apparatus 10.

The input interface 25 includes one or more interfaces for input. The interface for input is, for example, a physical key, a capacitive key, a pointing device, a touch screen integrally provided with a display, or a microphone that receives audio input. The input interface 25 accepts operations to input information used for operation of the server apparatus 10 and transmits the inputted information to the controller 23.

The output interface 26 includes one or more interfaces for output. The interface for output is, for example, a display or a speaker. The display is, for example, a liquid crystal display (LCD) or an organic electro-luminescent (EL) display. The output interface 26 outputs information obtained by the operations of the server apparatus 10.

The functions of the server apparatus 10 are realized by a processor included in the controller 23 executing a control program. The control program is a program for causing a computer to execute the processing of steps included in the operations of the server apparatus 10, thereby enabling the computer to realize the functions corresponding to the processing of the steps. That is, the control program is a program for causing a computer to function as the server apparatus 10. Some or all of the functions of the server apparatus 10 may be realized by a dedicated circuit included in the controller 23. The control program may be stored on a non-transitory recording/storage medium readable by the server apparatus 10 and be read from the medium by the server apparatus 10.

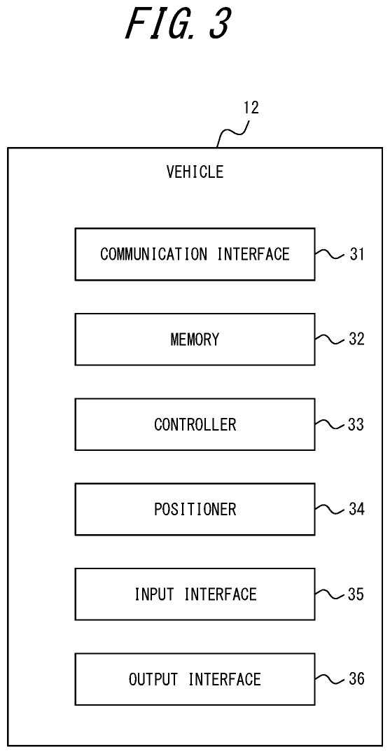

FIG. 3 illustrates a configuration example of the vehicle 12. The vehicle 12 includes a communication interface 31, a memory 32, a controller 33, a positioner 34, an input interface 35, and an output interface 36. These components may be configured as a single control apparatus, by two or more control apparatuses, or by other apparatuses, such as a control apparatus and a communication device. The control apparatus includes an electronic control unit (ECU), for example. The communication device includes a data communication module (DCM), for example. The control apparatus may be configured to include a personal computer, a tablet terminal, a smartphone terminal, a navigation apparatus, or the like. The components are communicably connected to each other, or to other devices and apparatuses in the vehicle 12, by an in-vehicle network compliant with standards such as a controller area network (CAN).

The communication interface 31 includes one or more interfaces for communication. Examples of the interface for communication include an interface corresponding to mobile communication standards, such as Long Term Evolution (LTE), 4th Generation (4G), or 5th Generation (5G). The communication interface 31 receives information to be used for the operations of the controller 33 and transmits information obtained by the operations of the controller 33. The controller 33 connects to the network 11 using the communication interface 31 through a mobile communication base station and communicates information with other apparatuses via the network 11.

The memory 32 includes, for example, one or more semiconductor memories, one or more magnetic memories, one or more optical memories, or a combination of at least two of these types. The semiconductor memory is, for example, RAM or ROM. The RAM is, for example, SRAM or DRAM. The ROM is, for example, EEPROM. The memory 32 functions as, for example, a main memory, an auxiliary memory, or a cache memory. The memory 32 stores information to be used for the operations of the controller 33 and information obtained by the operations of an in-vehicle apparatus 30.

The controller 33 includes one or more processors, one or more dedicated circuits, or a combination thereof. Examples of the processor include a general purpose processor such as a CPU and a dedicated processor dedicated to specific processing. The dedicated circuit is, for example, an FPGA or an ASIC. The controller 33 executes information processing related to operations of the vehicle 12 while controlling the components of the controller 33.

The positioner 34 includes one or more Global Navigation Satellite System (GNSS) receivers. The GNSS includes, for example, at least one of Global Positioning System (GPS), Quasi-Zenith Satellite System (QZSS), BeiDou, Global Navigation Satellite System (GLONASS), and Galileo. The positioner 34 acquires the positional information for the vehicle 12 and transmits the positional information to the controller 33.

The input interface 35 includes one or more interfaces for input. The interface for input is, for example, a physical key, a capacitive key, a pointing device, a touch screen integrally provided with a display, or a microphone that receives audio input. The interface for input may further include a camera or IC card reader that captures images or image codes. The input interface 35 accepts user operations to input information used for operation of the controller 33 and transmits the inputted information to the controller 33.

The output interface 36 includes one or more interfaces for output. The interface for output is, for example, a display or a speaker. The display is, for example, an LCD or an organic EL display. The output interface 36 outputs the information obtained by the operation of controller 33, for example, to the user.

The functions of the controller 33 are realized by a processor included in the controller 33 executing a control program. The control program is a program for causing a computer to execute the processing of steps included in operations of the controller 33, thereby enabling the computer to realize the functions corresponding to the processing of the steps. That is, the control program is a program for causing a computer to function as the controller 33. Some or all of the functions of the controller 33 may be realized by a dedicated circuit included in the controller 33.

The controller 33 generates information for control of various mechanisms and apparatuses of the vehicle 12 and transmits the information for control to the control circuits of the various mechanisms and apparatuses to control the mechanisms and apparatuses.

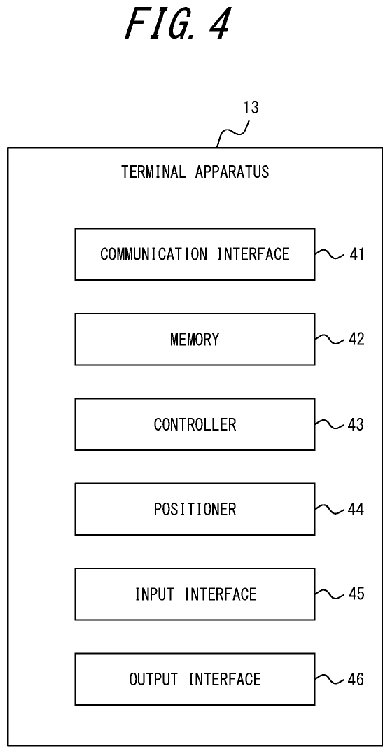

FIG. 4 is a diagram illustrating a configuration of the terminal apparatus 13. The terminal apparatus 13 is, for example, an information terminal apparatus such as a smartphone, a tablet terminal apparatus, or the like. The terminal apparatus 13 includes a communication interface 41, a memory 42, a controller 43, a positioner 44, an input interface 45, and an output interface 46.

The communication interface 41 includes a communication module compliant with a wired or wireless LAN standard, a module compliant with a mobile communication standard such as LTE, 4G, or 5G, or the like. The terminal apparatus 13 connects to the network 11 via a nearby router apparatus or mobile communication base station using the communication interface 41 and communicates information with other apparatuses over the network 11.

The memory 42 includes, for example, one or more semiconductor memories, one or more magnetic memories, one or more optical memories, or a combination of at least two of these types. The semiconductor memory is, for example, RAM or ROM. The RAM is, for example, SRAM or DRAM. The ROM is, for example, EEPROM. The memory 42 functions as, for example, a main memory, an auxiliary memory, or a cache memory. The memory 42 stores information to be used for the operations of the controller 43 and information obtained by the operations of the controller 43.

The controller 43 has one or more general purpose processors such as CPUs or micro processing units (MPUs) or one or more dedicated processors that are dedicated to specific processing. Alternatively, the controller 43 may have one or more dedicated circuits such as FPGAs or ASICs. The controller 43 is configured to perform overall control of the operations of the terminal apparatus 13 by operating according to the control/processing programs or operating according to operation procedures implemented in the form of circuits. The controller 43 then transmits and receives various types of information to and from the server apparatus 10 and the like via the communication interface 41 and executes the operations according to the present embodiment.

The positioner 44 includes one or more GNSS receivers. GNSS includes, for example, GPS, QZSS, BeiDou, GLONASS, and/or Galileo. The positioner 44 acquires the positional information for the terminal apparatus 13 and transmits the positional information to the controller 43.

The input interface 45 includes one or more interfaces for input. The interface for input is, for example, a physical key, a capacitive key, a pointing device, a touch screen integrally provided with a display, or a microphone that receives audio input. The interface for input may further include a camera or IC card reader that captures images or image codes. The input interface 45 accepts operations for inputting information to be used in the operations of the controller 43 and transmits the inputted information to the controller 43.

The output interface 46 includes one or more interfaces for output. The interface for output is, for example, a display or a speaker. The display is, for example, an LCD or an organic EL display. The output interface 46 outputs information obtained by the operations of the controller 43.

The functions of the controller 43 are realized by a processor included in the controller 43 executing a control program. The control program is a program for causing the processor to function as the controller 43. Some or all of the functions of the controller 43 may be realized by a dedicated circuit included in the controller 43.

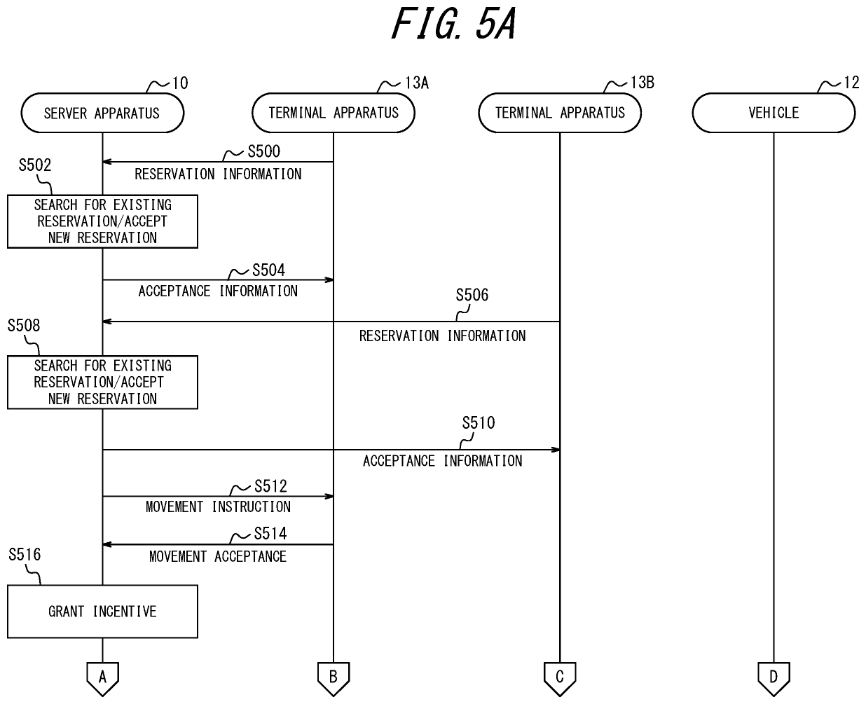

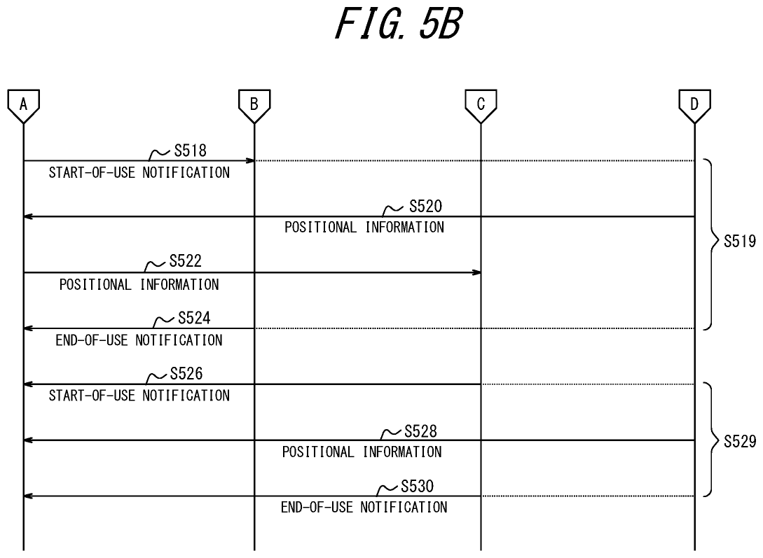

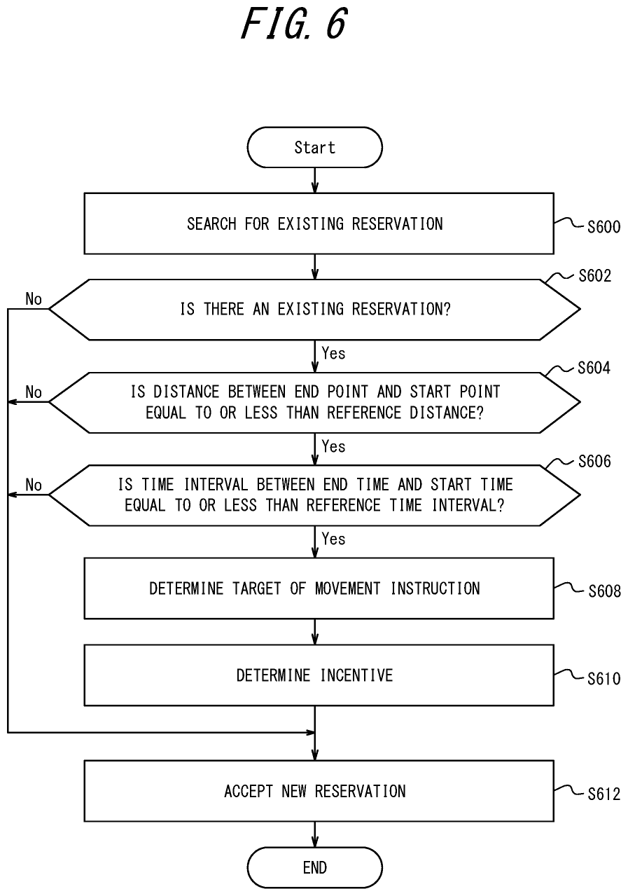

Next, operations of the information processing system 1 are described with reference to FIGS. 5A, 5B, and 6.

FIG. 5A and the subsequent FIG. 5B are sequence diagrams to illustrate the operating procedures of the information processing system 1 in the present embodiment. FIGS. 5A and 5B illustrate the procedures for coordinated operation of the server apparatus 10, the vehicle 12, and two terminal apparatuses 13 (referred to as the terminal apparatuses 13A and 13B for convenience). The steps pertaining to the various information processing by the server apparatus 10, the vehicle 12, and the terminal apparatuses 13 in FIGS. 5A and 5B are performed by the respective controllers 23, 33, 43. The steps pertaining to transmitting and receiving various types of information to and from the server apparatus 10, the vehicle 12, and the terminal apparatuses 13 are performed by the respective controllers 23, 33, 43 transmitting and receiving information to and from each other via the respective communication interfaces 21, 31, 41. In the server apparatus 10, the vehicle 12, and the terminal apparatuses 13, the respective controllers 23, 33, 43 appropriately store the information that is transmitted and received in the respective memories 22, 32, 42. Furthermore, the controllers 23, 33, 43 accept input of various information by the respective input interfaces 35, 45 and output various information by the respective output interfaces 36, 46.

In step S500, the terminal apparatus 13A transmits reservation information for reserving use of the vehicle 12 to the server apparatus 10. For example, the user of the terminal apparatus 13A uses the terminal apparatus 13A to access a portal site, for members of the car sharing service, provided by the server apparatus 10. The portal site displays, for example, the location of the stations, the vehicle type of the vehicles 12 available at each station, and the like. The user uses the terminal apparatus 13A to input the desired start time and start point of use, the desired end time and end point of use, the user's member ID, and the like, and transmits the inputted information to the server apparatus 10 as information to reserve use. The start point and end point may be a station or any other point. At this time, information identifying the terminal apparatus 13A is included in the reservation information.

In step S502, the server apparatus 10 searches for existing reservations that may affect the acceptance of a reservation based on the reservation information from the terminal apparatus 13A and accepts a new reservation according to the search result. The detailed procedure is described below in FIG. 6. Here, since no existing reservation exists, the server apparatus 10 accepts a new reservation based on the reservation information from the terminal apparatus 13A. Information identifying the terminal apparatus 13A, the user's membership ID, the start time and start point of use, the end time and end point of use, and the like are stored in the memory 22.

In step S504, the server apparatus 10 transmits acceptance information to the server apparatus 10. The acceptance information includes, for example, information such as the start time, start location, end time, and end location of the reserved use, along with authentication information for the terminal apparatus 13A to unlock the doors of the vehicle 12, start the engine, and the like.

In step S506, the terminal apparatus 13B performs the same operations as the terminal apparatus 13A in step S500 and transmits reservation information for reserving use of the vehicle 12 to the server apparatus 10.

In step S508, the server apparatus 10 searches for existing reservations that may affect the acceptance of a reservation based on the reservation information from the terminal apparatus 13B and accepts a new reservation according to the search result. The detailed procedures of step S508 and step S502 are described here with reference to FIG. 6.

FIG. 6 is a flowchart illustrating an example of the operation procedures for the controller 23 in the server apparatus 10.

In step S600, the controller 23 searches for existing reservations. An existing reservation is a confirmed reservation for the same vehicle type as the vehicle type specified in the reservation information for the new reservation transmitted by the terminal apparatus 13A or 13B. An existing reservation also has an end time before the start time of the new reservation. The controller 23 searches for the reservation information for existing reservations stored in the memory 22. In a case in which there is an existing reservation (Yes in step S602), the controller 23 proceeds to step S604. In a case in which there is no existing reservation (No in step S602), the controller 23 proceeds to step S612 and accepts the new reservation in step S612. The controller 23 stores the reservation information transmitted by the terminal apparatus 13A or 13B in the memory 22 as confirmed reservation information. In step S502 of FIG. 5A, the result of the determination in step S602 is No, and step S612 is executed.

In step S604, the controller 23 determines whether there is a reservation (referred to for convenience as a candidate reservation), among the existing reservations, for which the distance between the end point of use and the start point of use in the new reservation is equal to or less than a reference distance. The reference distance is a distance freely set in advance (such as several hundred meters to 2000 meters), and information on the reference distance is stored in the memory 22. In a case in which there is a candidate reservation (Yes in step S604), the controller 23 proceeds to step S606. In a case in which there is no candidate reservation (No in step S604), the controller 23 proceeds to step S612. In step S508 of FIG. 5, the reservation from the terminal apparatus 13A is determined to be a candidate reservation.

In step S606, the controller 23 determines whether the time interval between the end time of use in the candidate reservation and the start time of use in the new reservation is equal to or less than a reference interval. The reference interval is a length of time freely set in advance (such as several tens of minutes to an hour), and information on the reference interval is stored in the memory 22. In a case in which the time interval is equal to or less than the reference interval (Yes in step S606), the controller 23 proceeds to step S608. In such a case, the candidate reservation is subsequently referred to for convenience as a selected reservation. In a case in which the time interval is not equal to or less than the reference interval (No in step S606), the controller 23 proceeds to step S612. In step S508 of FIG. 5, it is determined that the candidate reservation from terminal apparatus 13A is a selected reservation for which the time interval between the end time of the candidate reservation and the start time of use in the new reservation is equal to or less than the reference interval.

These two conditions, i.e. the distance between the end point and start point and the time interval between the end time and start time, enable determination of a more effective selected reservation.

In step S608, the controller 23 determines the terminal apparatus 13 corresponding to the selected reservation as the target of a movement instruction. In step S508 of FIG. 5, the terminal apparatus 13A is determined as the target of the movement instruction.

In step S610, the controller 23 determines an incentive to be granted to the user of the terminal apparatus 13A determined to be the target of the movement instruction. The incentive is an economic value, such as points or a discount usable towards car sharing fees, or a refunds of fees. The controller 23 determines the incentive based on the distance between the end point in the selected reservation and the start point in the new reservation. For example, the incentive is determined by multiplying the distance between the two points by any appropriate factor determined in advance. For example, the incentive is determined to be greater as the distance between the two points is larger. Furthermore, the controller 23 adjusts the incentive according to the time interval between the end time in the selected reservation and the start time in the new reservation. For example, the incentive is adjusted by multiplying by an appropriate factor based on the time interval or by increasing or decreasing an appropriate adjustment amount based on the time interval. For example, the incentive is adjusted to be greater as the time interval is longer. A coefficient or incentive value corresponding to the combination of the distance between the end point in the selected reservation and the start point in the new reservation and the time interval between the end time in the selected reservation and the start time in the new reservation may be stored in the memory 22 in advance, and the controller 23 may use such information to determine the incentive.

In step S612, the controller 23 accepts the new reservation. In step S508 of FIG. 5, the controller 23 stores the reservation information on the new reservation transmitted by the terminal apparatus 13B in the memory 22 as confirmed reservation information.

Returning to FIG. 5A, in step S510, the server apparatus 10 transmits the acceptance information to the terminal apparatus 13B. The acceptance information includes, for example, information such as the start time, start location, end time, and end location of the reserved use, along with authentication information for the terminal apparatus 13B to unlock the doors of the vehicle 12, start the engine, and the like.

In step S512, the server apparatus 10 transmits the movement instruction to the terminal apparatus 13A. The movement instruction includes information on the start location and start time in the reservation made by the terminal apparatus 13B and an instruction to move to the start location by the start time. The terminal apparatus 13A outputs the movement instruction for presentation to the user of the terminal apparatus 13A.

In step S514, the terminal apparatus 13A transmits information on movement acceptance to the server apparatus 10. When operation input from the user to accept the movement instruction is performed, the terminal apparatus 13A transmits information on the movement acceptance to the server apparatus 10 in response.

Upon receiving the movement acceptance, the server apparatus 10 performs a process to grant an incentive to the user of the terminal apparatus 13A in step S516. The server apparatus 10 performs the process to grant an incentive using, for example, account information stored in advance in association with the ID of the user of the terminal apparatus 13A. Making the acceptance of the movement a condition for granting the incentive ensures that the user of the terminal apparatus 13A will feel convinced and can also prevent the granting of incentives in error. By the incentive being granted, the user of the terminal apparatus 13A receives economic compensation for cooperating by moving the vehicle 12 to the start point of use by the user of the terminal apparatus 13B and can experience greater satisfaction.

When the user of the terminal apparatus 13A starts using the vehicle 12, the terminal apparatus 13A transmits a start-of-use notification to the server apparatus 10 in step S514. For example, upon unlocking and starting the vehicle 12 using the authentication information, the terminal apparatus 13A transmits the start-of-use notification to the server apparatus 10.

Upon acquiring the use notification from the terminal apparatus 13A, the server apparatus 10 acquires positional information from the vehicle 12 in step S520. Then, in step S522, the server apparatus 10 transmits the positional information for the vehicle 12 obtained from the vehicle 12 to the terminal apparatus 13B. When the vehicle 12 is being used by the user of the terminal apparatus 13A (S519), the positional information for the vehicle 12 is transmitted from the vehicle 12 to the server apparatus 10 at any appropriate time intervals, and the positional information is then transmitted to the terminal apparatus 13B at any appropriate time intervals. This enables the user of the terminal apparatus 13B to recognize the position of the vehicle 12.

When the vehicle 12 arrives at the start point of use by the terminal apparatus 13B and the user of the terminal apparatus 13A finishes using the vehicle 12, the terminal apparatus 13A transmits an end-of-use notification to the server apparatus 10 in step S524. For example, upon locking the vehicle 12 using the authentication information, the terminal apparatus 13A transmits an end-of-use notification to the server apparatus 10.

When the user of the terminal apparatus 13B starts using the vehicle 12, the terminal apparatus 13B transmits a start-of-use notification to the server apparatus 10 in step S526. For example, upon unlocking and starting the vehicle 12 using the authentication information, the terminal apparatus 13B transmits the start-of-use notification to the server apparatus 10.

Upon acquiring the use notification from the terminal apparatus 13B, the server apparatus 10 acquires positional information from the vehicle 12 in step S528. When the vehicle 12 is being used by the user of the terminal apparatus 13B (S529), the positional information for the vehicle 12 is transmitted from the vehicle 12 to the server apparatus 10 at any appropriate time intervals. The server apparatus 10 may further transmit the positional information for the vehicle 12 acquired from the vehicle 12 to other terminal apparatuses 13.

When the user of the terminal apparatus 13B finishes using the vehicle 12, the terminal apparatus 13B transmits an end-of-use notification to the server apparatus 10 in step S530. For example, upon locking the vehicle 12 using the authentication information, the terminal apparatus 13B transmits an end-of-use notification to the server apparatus 10.

FIGS. 5A and 5B illustrate the procedures in a case in which use by the user of the terminal apparatus 13A is followed by use by the user of the terminal apparatus 13B. However, in a case in which use by the user of the terminal apparatus 13B is followed by use by the user of yet another terminal apparatus 13, for example, the server apparatus 10 may transmit a movement instruction to the terminal apparatus 13B and perform a process to grant an incentive to the user of the terminal apparatus 13B.

According to the information processing system 1, the latter user during consecutive uses of the vehicle 12 can start using the vehicle 12 at the desired location, which improves the management of the vehicle 12 by contributing to user convenience. On the other hand, the earlier user is compensated by an incentive for the burden of moving the vehicle 12 to the start point of use by the latter user. At this time, the amount of the incentive increases with the time interval or distance for travel, thereby improving user satisfaction.

In the above embodiment, a processing/control program that specifies operations of the vehicle 12 and the terminal apparatus 13 may be stored in the memory 22 of the server apparatus 10 or in the memory of another server apparatus and be downloaded onto each apparatus via the network 11. The processing/control program may also be stored on a non-transitory recording/storage medium readable by each apparatus, and each apparatus may read the program from the medium.

While embodiments have been described with reference to the drawings and examples, it should be noted that various modifications and revisions may be implemented by those skilled in the art based on the present disclosure. Accordingly, such modifications and revisions are included within the scope of the present disclosure. For example, functions or the like included in each means, each step, or the like can be rearranged without logical inconsistency, and a plurality of means, steps, or the like can be combined into one or divided.

1. A server apparatus comprising:
a communication interface; and
a controller configured to transmit and receive information to and from other apparatuses via the communication interface, wherein
when the controller receives information for reserving use of a vehicle from a terminal apparatus, and a distance between an end point of a first use and a start point of a second use that starts after the first use is equal to or less than a reference distance, the controller is configured to transmit a movement instruction to a first terminal apparatus corresponding to the first use for a user to move the vehicle to the start point of the second use at an end of the first use.

2. The server apparatus according to claim 1, wherein the controller is configured to transmit the movement instruction to the first terminal apparatus under a further condition that an interval between an end time of the first use and a start time of the second use is equal to or less than a reference interval.

3. The server apparatus according to claim 1, wherein the controller is configured to perform a process of granting an incentive to the user for the first use according to the distance between the end point of the first use and the start point of the second use.

4. The server apparatus according to claim 2, wherein the controller is configured to perform a process of granting an incentive to the user for the first use according to the interval between the end time of the first use and the start time of the second use.

5. The server apparatus according to claim 3, wherein the controller is configured to perform a process of granting an incentive to the user for the first use under a condition that the movement instruction is accepted.

6. The server apparatus according to claim 1, wherein the controller is configured to receive positional information from the vehicle at a time of the first use and transmit the positional information to a second terminal apparatus corresponding to the second use.

7. The server apparatus according to claim 6, wherein the controller is configured to receive the positional information from the vehicle after receiving a notification from the first terminal apparatus indicating that use of the vehicle has started.

8. A system comprising a server apparatus and a plurality of terminal apparatuses, the server apparatus and the terminal apparatuses being configured to transmit and receive information to and from each other, wherein
when the server apparatus receives information for reserving use of a vehicle from a terminal apparatus among the plurality of terminal apparatuses, and a distance between an end point of a first use and a start point of a second use that starts after the first use is equal to or less than a reference distance, the server apparatus is configured to transmit a movement instruction to a first terminal apparatus corresponding to the first use for a user to move the vehicle to the start point of the second use at an end of the first use, and
the first terminal apparatus receives the movement instruction.

9. The system according to claim 8, wherein the server apparatus is configured to transmit the movement instruction to the first terminal apparatus under a further condition that an interval between an end time of the first use and a start time of the second use is equal to or less than a reference interval.

10. The system according to claim 8, wherein the server apparatus is configured to perform a process of granting an incentive to the user for the first use according to the distance between the end point of the first use and the start point of the second use.

11. The system according to claim 9, wherein the server apparatus is configured to perform a process of granting an incentive to the user for the first use according to the interval between the end time of the first use and the start time of the second use.

12. The system according to claim 10, wherein the server apparatus is configured to perform a process of granting an incentive to the user for the first use under a condition that the movement instruction is accepted.

13. The system according to claim 8, wherein the server apparatus is configured to receive positional information from the vehicle at a time of the first use and transmit the positional information to a second terminal apparatus corresponding to the second use, and the second terminal apparatus is configured to receive the positional information.

14. The system according to claim 13, wherein the server apparatus is configured to receive the positional information from the vehicle after receiving a notification from the first terminal apparatus indicating that use of the vehicle has started.

15. An operating method of a system comprising a server apparatus and a plurality of terminal apparatuses, the server apparatus and the terminal apparatuses being configured to transmit and receive information to and from each other, the operating method comprising:
transmitting, by the server apparatus, a movement instruction when the server apparatus receives information for reserving use of a vehicle from a terminal apparatus among the plurality of terminal apparatuses, and a distance between an end point of a first use and a start point of a second use that starts after the first use is equal to or less than a reference distance, the server apparatus transmitting the movement instruction to a first terminal apparatus corresponding to the first use for a user to move the vehicle to the start point of the second use at an end of the first use; and
receiving, by the first terminal apparatus, the movement instruction.

16. The operating method according to claim 15, wherein the server apparatus transmits the movement instruction to the first terminal apparatus under a further condition that an interval between an end time of the first use and a start time of the second use is equal to or less than a reference interval.

17. The operating method according to claim 15, wherein the server apparatus performs a process of granting an incentive to the user for the first use according to the distance between the end point of the first use and the start point of the second use.

18. The operating method according to claim 16, wherein the server apparatus performs a process of granting an incentive to the user for the first use according to the interval between the end time of the first use and the start time of the second use.

19. The operating method according to claim 17, wherein the server apparatus performs a process of granting an incentive to the user for the first use under a condition that the movement instruction is accepted.

20. The operating method according to claim 15, wherein
the server apparatus receives positional information from the vehicle at a time of the first use and transmits the positional information to a second terminal apparatus corresponding to the second use, and
the second terminal apparatus receives the positional information.
